(19) United States
(12) Patent Application Publication
(10) Pub. No.: US 2019/0057360 A1
(43) Pub. Date: Feb. 21, 2019

(54) DIGITAL MEMORABILIA SYSTEM WITH CYCLE-BASED GREETING SCHEDULER FUNCTIONS

(71) Applicant: Chatalyze, Inc., Menlo Park, CA (US)

(72) Inventors: Lloyd Winawer, Menlo Park, CA (US); Jordan Isaiah Winawer, Menlo Park, CA (US)

(73) Assignee: Chatalyze, Inc., Menlo Park, CA (US)

(21) Appl. No.: 16/105,605

(22) Filed: Aug. 20, 2018

Related U.S. Application Data
(60) Provisional application No. 62/548,135, filed on Aug. 21, 2017.

(51) Int. Cl. G06Q 10/10; G06Q 50/00

(52) U.S. Cl. CPC G06Q 10/1097; G06Q 50/01

(57) ABSTRACT

A system directed to scheduling generation of digital memorabilia or collectible items (such as digitally-inscribed items). Particular implementations are directed to a cycle-based mechanism that controls requested delivery times for digital memorabilia greetings based on a maximum number of greetings for a particular analyst in a given cycle.

### CROSS-REFERENCE TO RELATED APPLICATION

The present application claims priority to U.S. provisional application Ser. No. 62/548,135, filed on Aug. 21, 2017, which is incorporated herein by reference for all purposes.

### BACKGROUND

### Field of the Disclosure

The disclosure relates generally to digital memorabilia systems and electronic greetings.

### Description of Related Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Social media and internet-based communications systems are known. Many celebrities employ social media systems (such as Twitter, Facebook, Instagram, and the like) to broadcast and disseminate information to their followers. Social media influencers—i.e., those with large groups of followers—and many other persons-of-interest and celebrities (whether in sports, literature, television, radio, music, theater or other forms of entertainment or information delivery)—have no readily available, practical and/or secure methods to engage directly and personally with individual followers.

Sports memorabilia and collectibles is a multi-billion-dollar market. One segment of the market involves authentic signatures obtained from current and former professional athletes. Traditionally, signing events are organized to provide opportunities for sports fans to obtain signatures from current and former players associated with various professional athletic leagues, such as Major League Baseball. These signing events, however, often require the players to typically expend more time traveling to and from a particular venue than the time spent meeting fans and providing autographs. The same issues may exist for other vertical markets involving signing events, such as movie and comic conventions.

Electronic or digital memorabilia systems have been proposed to extend the monetization opportunities for interactions and engagement of the type generally described. These systems may provide a mechanism for a subject to generate a signature that is applied to a digital content object, such as a digital image or to sell inscribed merchandise or provide other personally tailored deliverables or examples of monetization methods to a customer, patron, fan or other user.

### SUMMARY OF THE DISCLOSURE

Embodiments of the present disclosure are directed to scheduling the generation of digital memorabilia or collectible items (such as digitally-inscribed items). Particular implementations are directed to a cycle-based mechanism that controls requested delivery times for new digital memorabilia greetings based on a maximum number of greetings for a particular analyst in a given cycle.

### BRIEF DESCRIPTION OF THE DRAWINGS

FIG. 1 illustrates a network computer system environment for implementing embodiments of the disclosure.

FIG. 2 is a flow chart diagram illustrating a method for implementing embodiments of the disclosure.

FIG. 3 is a flow chart diagram illustrating a method for implementing embodiments of the disclosure.

FIG. 4 is a time series diagram illustrating operation of a scheduling process according to one implementation of the disclosure.

FIGS. 5A and 5B are schematics illustrating analyst graphical user interfaces for implementing embodiments of the disclosure.

FIGS. 6A and 6B are schematics illustrating user graphical user interfaces for implementing embodiments of the disclosure.

FIGS. 7A and 7B illustrating example scheduling controls that can be integrated or used in connection with implementations of the present disclosure.

FIG. 8 illustrates an example of a computer system that may be used to execute program code to implement embodiments of the disclosure.

### DETAILED DESCRIPTION

The present description is made with reference to the accompanying drawings, in which various example embodiments are shown. However, many different example embodiments may be used, and thus the description should not be construed as limited to the example embodiments set forth herein. Rather, these example embodiments are provided so that this disclosure will be thorough and complete. Various modifications to the exemplary embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein.

In embodiments of the disclosure, “analyst” refers to an entity that creates digital greetings using the system described herein, such as a social influencer or other persons of-interest and celebrities, whether in sports, literature, television, radio, music, theater or other forms of entertainment or information delivery, to one or more customers, patrons, fans, followers or other users. An analyst can be a social influencer, celebrity (including a current or former professional athlete), an actor or other person for whom there exists a market of customers, patrons, fans or other users desiring and, in some instances, willing to pay for personal, digital greetings created by such person. As used herein, “user” refers to an individual user of the system that orders and/or receives a digital greeting. Individuals may assume certain roles in the system depending on the context.

In some implementations described below, users order digital greetings to be created by a selected analyst. The analyst creates the greeting according to a defined schedule and uploads it to digital memorabilia system 104, which delivers the greeting on the requested delivery date. The digital greeting is delivered to a recipient, which could be another user or the user that ordered the digital greeting. A digital greeting is a digital content object or collection of digital content objects associated with an analyst. The digital greeting may include a video message created by the analyst and/or a digital inscription.

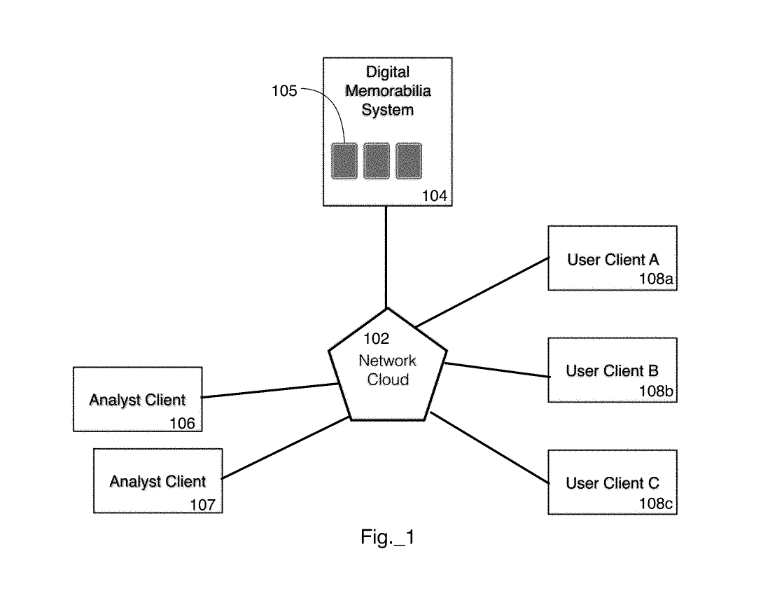

FIG. 1 illustrates a distributed system in which embodiments of the disclosure may operate. In embodiments, the distributed system may include digital memorabilia system 104, one or more analyst clients 106, one or more analyst clients 107, and one or more user clients 108a-c. The foregoing components of the system communicate over network cloud 102. Network cloud 102 comprises one or more telecommunications networks over which the various components of the system communicate. Network cloud 102 can include, without limitation, one or more of any of the following network types: local area networks, wide area networks, wireless cellular networks, cable networks, the Internet, and the like. Digital memorabilia system 104 comprises one or more servers 105 that communicates with analyst clients 106, 107 and user clients 108a-c over network 102. The server(s) 105 are coupled locally or remotely to one or more databases and/or content data stores, which may include one or more corpora of libraries including data such as image data, digital memorabilia data, analyst account data, user account data, and the like. In embodiments, the server(s) 105, analyst client 106, analyst client 107 and user clients 108a-c each include at least one processor and at least one memory storing instructions that, when executed by the processor(s), perform the communications and other workflows described below according to embodiments of the disclosure.

Digital memorabilia system 104, in some implementations, provides the operational and management hub for the system, maintaining (among other things) analyst accounts and user accounts. A user may have a user account that includes profile information (e.g., name, user identifiers, email address, payment information, etc.), account history information, and one or more items of digital memorabilia. Digital memorabilia and digital greetings refer to digital content having an association with a person-of-interest that, in some implementations, has a personal video message and/or content that has been digitally inscribed (e.g., autographed) by the person-of-interest. The digital content may be content related to, suggestive or representative of, a person of interest, such as a photographic image of the person-of-interest, or an animated image or video of the person of interest. In some implementations, digital memorabilia system 104 also supports work flows that allow a user to order physical products (e.g., shirts, coffee mugs, posters, baseballs, and the like) with images of the digital memorabilia stored in association with the user's profile.

Digital memorabilia system 104, in certain embodiments, also includes functionality directed to supporting the scheduling and creation of digital greetings by analysts. In particular implementations, an analyst can establish an analyst account and configure greeting controls directed or related to the scheduling function for creating digital greetings ordered by users. To that end, digital memorabilia system 104 also includes functionality directed to allowing users to order digital greetings from selected analysts, receive uploaded digital greetings from analysts, and deliver the greetings to recipient users. In some implementations, a request or order for a digital greeting identifies an ordering user, an analyst, a delivery time, and a recipient user. In one implementation, the delivery time includes a date (day-month-year) and a time of day. Additional data items may include notes related to the recipient user or specific requests or context behind the greeting (such as an upcoming birthday or other event). To deliver a digital greeting, digital memorabilia system 104 may send a message (e.g., email, SMS or text) to the recipient user with a link to the digital greeting. The recipient user may activate the link to access the digital greeting.

Digital memorabilia system 104 may allow the recipient user to download the digital greeting and/or store it in connection with a user account hosted by digital memorabilia system 104.

Analyst client 106 may be a desktop computer or laptop computer. The analyst may use analyst client 106 for configuring the parameters associated with the digital greeting schedules and/or to create digital greetings. In the embodiment shown, analyst client 107 may be a tablet, phablet, smartphone or any other system with a touchscreen user-interface device. In one implementation, analyst client 107 may further include a digital pen or stylus that facilitates the inscription process. As discussed below, the analyst may use analyst client 107 to digitally inscribe a digital object (e.g., such as autographing an object and/or writing a short note) associated with a digital greeting request. The functionality described below can be implemented in the context of a browser, a browser plug-in and/or a special-purpose client application executing on analyst client 106 and/or analyst client 107.

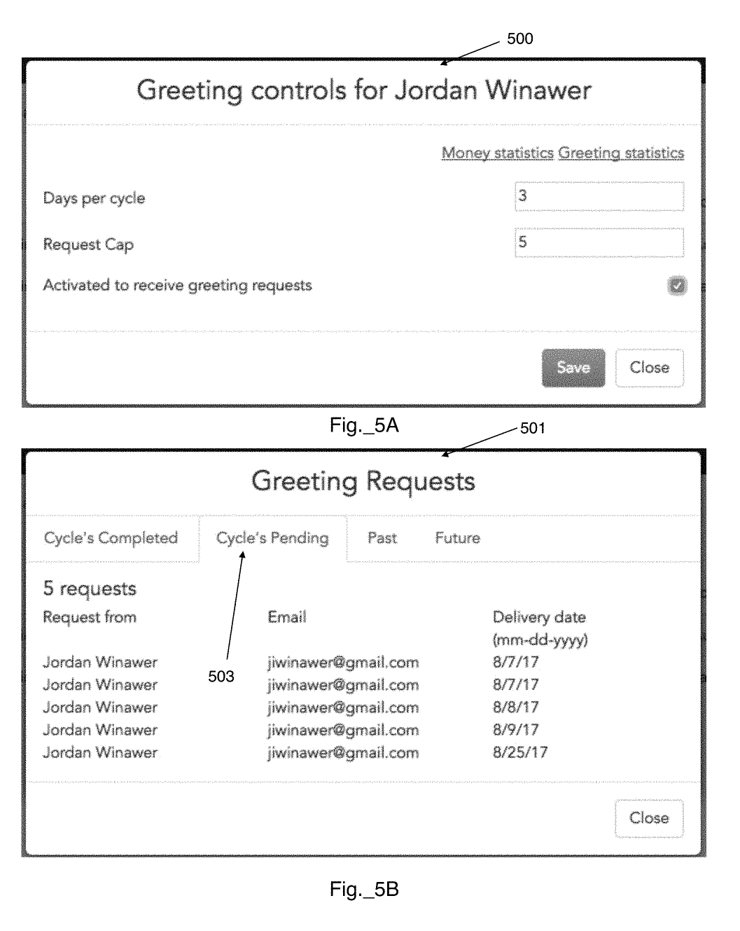

An analyst or a system administrator, using analyst client 106 or 107 may access digital memorabilia system 104 to configure digital greeting controls. FIG. 5A illustrates an example graphical user interface 500 that digital memorabilia system 104 presents to the analyst. As shown, the greeting controls interface 500 allows the analyst to configure a cycle length (in one embodiment, defined as a number of days) and a capacity limiting the number of greetings to be created in a given cycle (Request Cap). In some implementations, interface 500 allows the analyst to toggle the digital greeting scheduling system to either an activated or de-activated state as to that analyst. In one implementation, digital memorabilia system 104 uses these parameters in a greeting creation workflow that repeats in a series of consecutive cycles until the analyst elects to terminate the workflow.

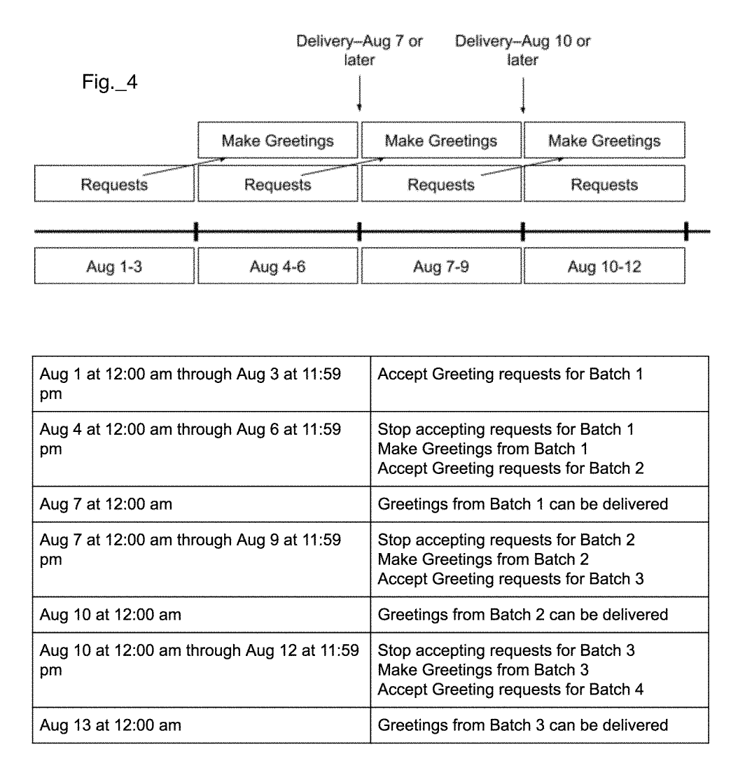

As discussed below, the digital greeting scheduling functionality of digital memorabilia system 104 uses these values to control the scheduling of digital greetings ordered by users. FIG. 4 illustrates an example scheduling flow that may result in connection with a hypothetical analyst and greeting campaign configuration. The example illustrated in FIG. 4 assumes that the analyst has configured a cycle length of three (3) days. As shown, the first cycle starts on August 1 at 12:00:00 am and ends at 11:59:59 pm on August 3. Consecutive cycles of the same length follow, unless the analyst toggles the scheduling controls to de-activate scheduling of new orders or requests. As FIG. 4 illustrates, the greeting scheduling function is designed such that (a) the analyst has at least one full cycle length to create any given greeting, and (b) that he/she creates only a maximum number of greetings in a cycle that ends before the respective delivery dates of the greetings, and (c) greetings are scheduled for delivery in a cycle following (consecutive or later) the cycle in which the greeting was created. Specifically, as FIG. 4 illustrates, greetings associated with requests received in a given cycle are scheduled for creation in the next consecutive cycle or a later cycle depending on the delivery time of the respective greetings. In one implementation, greetings associated with requests received in any given cycle are scheduled for creation in the next consecutive cycle regardless of delivery date, unless the maximum greeting capacity is reached. In some implementations, digital memorabilia system 104 may adjust the greeting creation schedule to move scheduled greetings to later cycles depending on their respective delivery times. As FIG. 4 also illustrates, the analyst creates greetings in a cycle for delivery in a later cycle, while digital memorabilia system 104 accepts new greeting requests during the cycle.

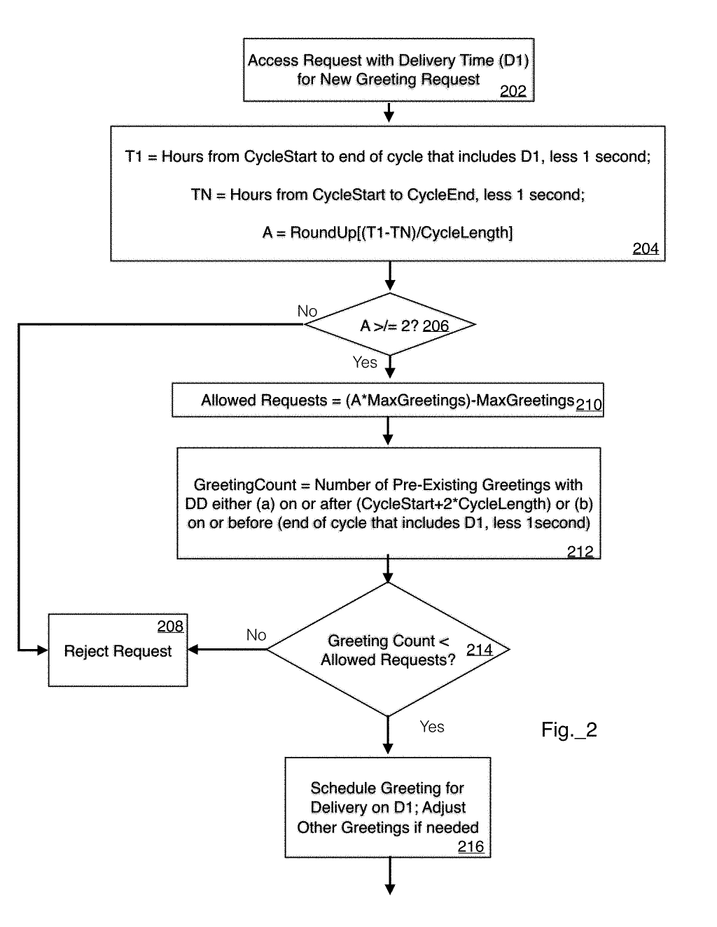

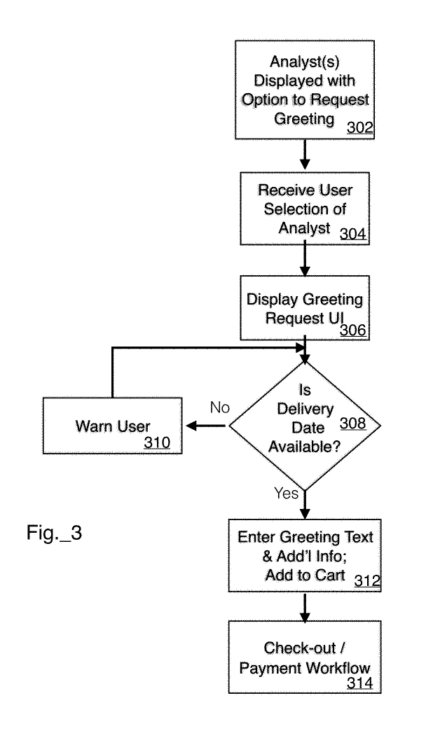

As discussed more fully below, FIGS. 2 and 3 illustrate processes by which greeting requests are received and accepted to assist in the scheduling workflows described herein. In the implementation shown, FIG. 3 illustrates an overall workflow whereby a user may order a greeting. The workflow illustrated in FIG. 3 may call or utilize the process illustrated in FIG. 2 to accept or reject a given greeting request.

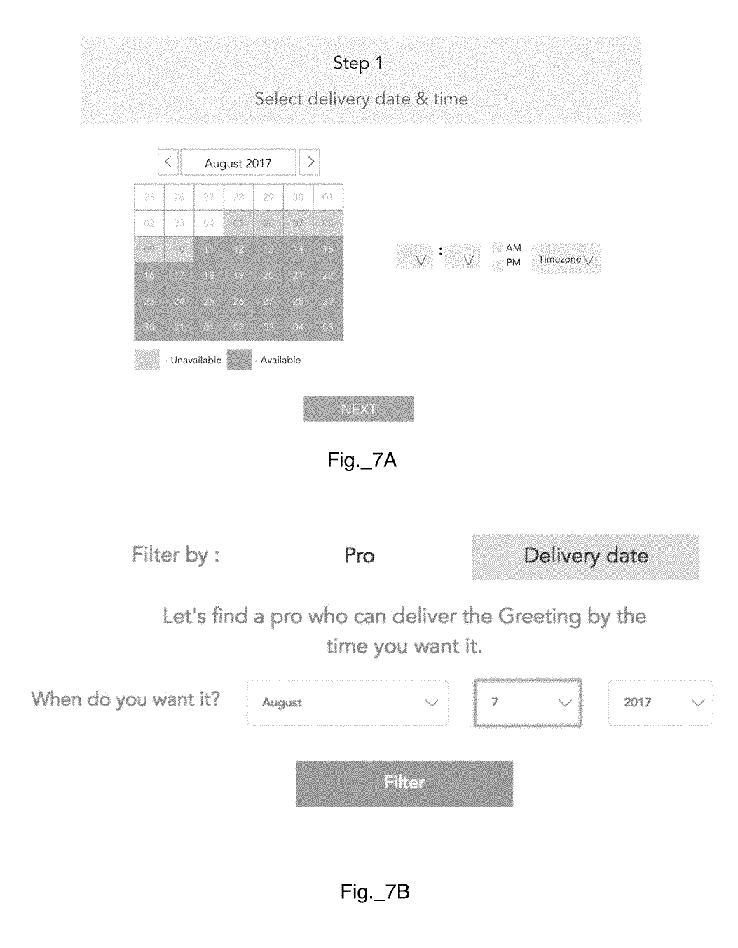

In some implementations, a user, using user client 108a, may access digital memorabilia system 104 to request a greeting from a given analyst. As FIG. 3 illustrates, digital memorabilia system 104 may provide a user interface presenting the user with one or more analysts and the option to request a digital greeting (302). For example, the user interface presented to the user may include a selectable control that initiates a greeting request workflow. In the implementation shown, digital memorabilia system 104 may receive the user's selection of an analyst (304) and display a greeting request user interface to the user (306). FIGS. 7A and 7B show example user interface components that digital memorabilia system 104 may provide to facilitate scheduling the delivery time for a greeting. For example, using the interface depicted in FIG. 7B may cause digital memorabilia system 104, using the scheduling function illustrated in FIG. 2, to find one or more analysts that can deliver a greeting on the requested delivery time. Digital memorabilia system 104 may employ the user interface depicted in FIG. 7A in connection with a particular analyst. For example, digital memorabilia system 104, prior to serving the user interface in FIG. 7A, may call the scheduling function of FIG. 2 to determine which days of the currently displayed month a request for a greeting with an associated delivery time can be accepted.

As FIG. 3 shows, if the delivery date is unavailable (308), the user is warned in some way (310). If the delivery date is available, the request workflow proceeds to additional phases, such as entering greeting text, recipient user identification information (name, email address, and the like), as well as adding the completed order to a cart (312). Later, the user may opt to check out and complete a payment workflow to schedule the order (314).

FIG. 2 illustrates a process that a scheduling module of digital memorabilia system 104 may use to assess a greeting request corresponding to a given analyst and an associated delivery time. In one embodiment, the scheduling module accesses a request that identifies an analyst and a corresponding delivery time (202) and computes a set of variables used in the accept/reject decision (204). In one implementation, all time references are converted to Coordinated Universal Time (UTC) prior to the operations described in connection with FIG. 2. In the implementation shown, scheduling module sets variable T1 to the difference in hours from CycleStart (the start time of the current cycle) to the end of the cycle that includes requested delivery time D1, less 1 second. In the implementation described herein, the initial value of CycleStart is set to 12:00 AM on the day the analyst or other administrator enabled the greeting scheduling function and repeats every CycleLength (the number of days in the cycle configured by the analyst). Scheduling module also sets variable TN to the difference in hours from CycleStart to EndCycle (the end time of the current cycle), less 1 second. Scheduling module sets variable A to the rounded up, whole number value of the equation (T1−TN)/CycleLength.

In the implementation shown, scheduling module rejects the request (208), if A is not greater than or equal to 2 (206). This check enforces the constraint that D1 be sufficiently far away to allow an analyst at least one full cycle to complete the greeting. Assuming check (206) is met, scheduling module then sets the number of allowed requests based on the number of cycles associated with variable A. In the implementation shown, scheduling module sets the number of allowed requests to the difference between (a) the product of A and the greeting capacity configured by the analyst (MaxGreetings) and (b) MaxGreetings (210). Scheduling module then counts the number of pre-existing greetings (i.e., previously scheduled greetings for the analyst) having a delivery time (DD) either (a) on or after current CycleStart plus 2*CycleLength, or (b) on or before end of cycle including D1, less 1 second (212). If the Greeting Count is less than the number of allowed requests (214), scheduling module schedules the greeting for delivery on the requested delivery time (D1), adjusting as needed the creation schedule for greetings (as discussed below) (216). Otherwise, scheduling module rejects the request (208). In other words, the scheduling module evaluates whether all cycles in the schedule that precede the delivery time include a number of non-movable, pre-existing scheduled greetings that equals the maximum greeting value. In some implementations, a non-movable, pre-existing scheduled greeting is a pre-existing scheduled greeting having a delivery time that lies within a cycle corresponding to the delivery time of the requested greeting. This process is essentially reset or repeated with each new cycle.

Actual scheduling of the request, assuming it passes the processes described above, depends on the delivery time of the request and, in some instances, the number and respective delivery times of the pre-existing greetings that have already been scheduled. In some implementations, the scheduling module selects a cycle for creation of the requested greeting that both precedes the first delivery time and includes less than the maximum greeting value. For example, if the number of pre-existing greetings scheduled to be created in the immediately following cycle is below MaxGreetings, then scheduling module schedules the instant greeting to be created in that next cycle, even though the requested delivery time (D1) may not occur for many cycles later. In some instances, a pre-existing greeting with a delivery time later than the requested delivery time (D1) may be moved, if its associated delivery time occurs in a cycle that allows at least one full cycle for the analyst to create it. For example, the scheduling module may select a first pre-existing scheduled greeting in a corresponding cycle that can be moved to a subsequent cycle, and schedule the requested digital greeting in the corresponding cycle and re-schedule the first pre-existing scheduled greeting in the subsequent cycle. In some implementations, if the next cycle includes a number pre-existing scheduled greetings to be created in that cycle equal to MaxGreetings and the delivery time precedes the end of a third cycle immediately following the next cycle, then scheduling module may evaluate whether a first pre-existing scheduled greeting in the next cycle can be moved to a subsequent cycle following the second cycle based on a delivery time associated with the first pre-existing scheduled greeting, and schedule the requested digital greeting for creation in the second cycle and the pre-existing scheduled greeting for creation in the third cycle that follows the next cycle.

The timing of D1 may also control when the analyst is notified of the new greeting request. For example, if D1 is less than or equal to the time (CycleEnd+(2*Cyclelength), less 1 second), then digital memorabilia system 104, in one implementation, transmits a notification to the analyst within sixty seconds of scheduling the request. On the other hand, if D1 is greater than the time (CycleEnd+(2*Cyclelength), less 1 second), digital memorabilia system 104 withholds transmission of a notification in case another request arrives during the cycle that is earlier than this comparison time. In other implementations, the request notifications are batched and sent at the start of a cycle.

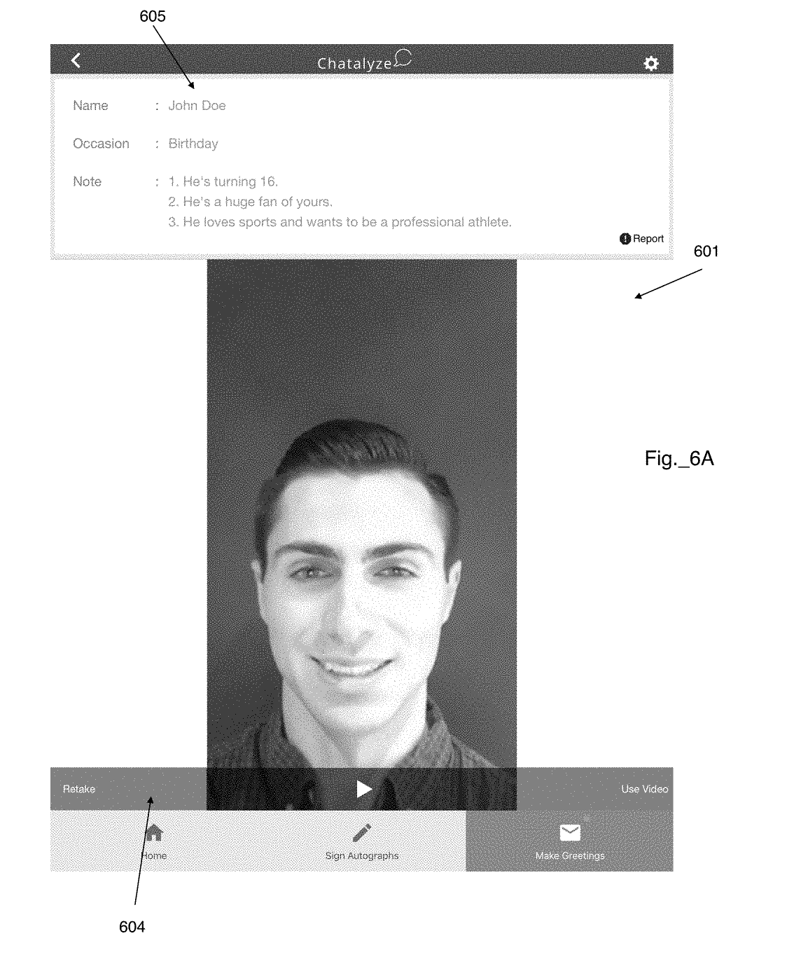

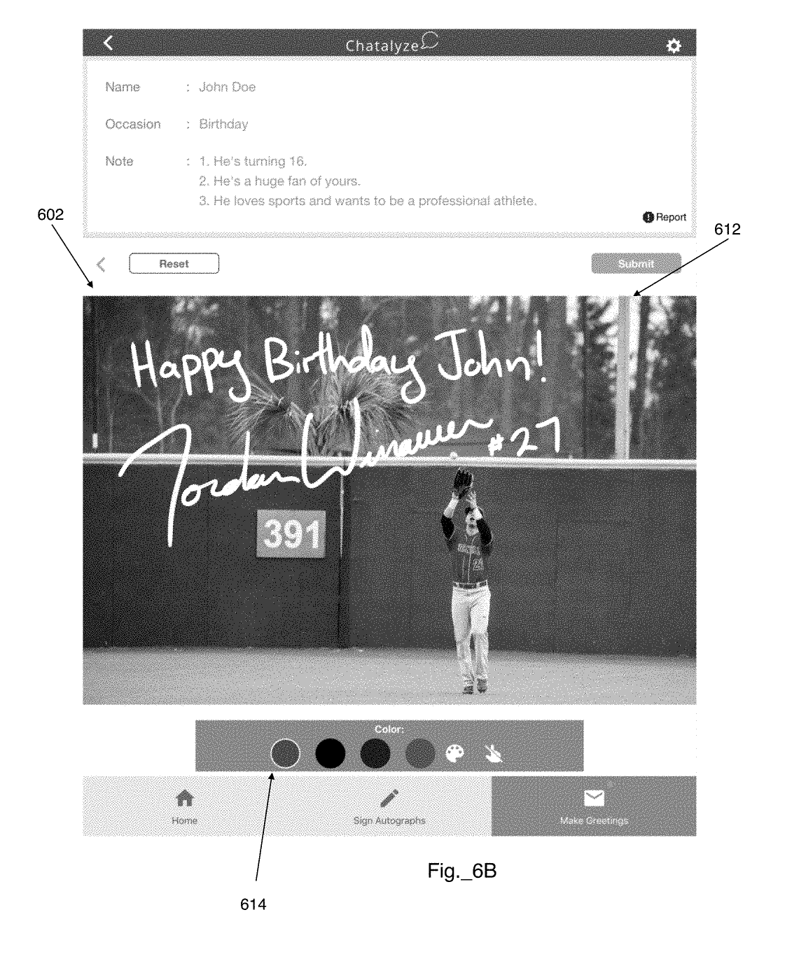

FIG. 5B illustrates an example interface that digital memorabilia system 104 may provide to an analyst. In the implementation shown, user interface 501 includes a tab 503 that shows the greetings to be created in a current cycle. In one implementation, analyst may use analyst client 106 and/or analyst client 107 to create a greeting and upload it to digital memorabilia system 104 for later delivery. In one implementation, a digital greeting comprises both a short video authored by the analyst and digital content inscribed by the analyst. FIGS. 6A and 6B illustrate example greeting creation interfaces 601, 602 that may be provided by a web application or an application installed on analyst client 107. Interface 601 facilitates creation of a video greeting. Interface 601 includes greeting information section 605 including information relating to the recipient user and the occasion or other information related to the greeting request. Interface 601 also includes control section 604 directed to recording the video, replaying it and submitting it for upload. Interface 602 facilitates inscription of digital content. Interface 602 includes a canvas section 612 displaying an item of digital content to be inscribed and a controls section 614 for controlling one or more inscription parameters, such as color, brush width, etc. In one implementation, the client-side application steps the analyst through both interfaces to create a greeting and uploads the completed greeting to digital memorabilia system 104. In some implementations, analyst client 107 and/or digital memorabilia system 104 may digitally sign the digital greeting with a digital certificate, using cryptographic technologies.

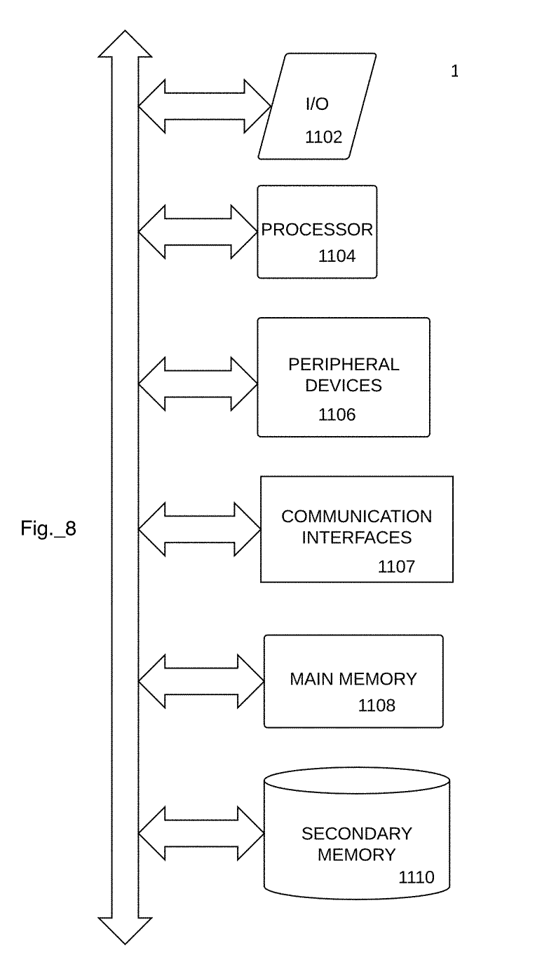

FIG. 8 illustrates an example of a computer system 1100 that may be used to execute program code stored in a non-transitory computer readable medium (e.g., memory) in accordance with embodiments of the disclosure. Any of servers 105, user clients 108a-c, and analyst clients 106, 107 may incorporate the computer system architecture illustrated in the following description. The computer system includes an input/output subsystem 1102, which may be used to interface with human users and/or other computer systems depending upon the application. The I/O subsystem 1102 may include, e.g., a keyboard, mouse, graphical user interface, touchscreen, or other interfaces for input, and, e.g., an LED or other flat screen display, or other interfaces for output, including application program interfaces (APIs). Other elements of embodiments of the disclosure, such as the prioritization engine may be implemented with a computer system like that of computer system 1100.

Program code may be stored in non-transitory media such as persistent storage in secondary memory 1110 or main memory 1108 or both. Main memory 1108 may include volatile memory such as random access memory (RAM) or non-volatile memory such as read only memory (ROM), as well as different levels of cache memory for faster access to instructions and data. Secondary memory may include persistent storage such as solid state drives, hard disk drives or optical disks. One or more processors 1104 reads program code from one or more non-transitory media and executes the code to enable the computer system to accomplish the methods performed by the embodiments herein. Those skilled in the art will understand that the processor(s) may ingest source code, and interpret or compile the source code into machine code that is understandable at the hardware gate level of the processor(s) 1104. The processor(s) 1104 may include graphics processing units (GPUs) for handling computationally intensive tasks.

The processor(s) 1104 may communicate with external networks via one or more communications interfaces 1107, such as a network interface card, WiFi transceiver, etc. A bus 1105 communicatively couples the I/O subsystem 1102, the processor(s) 1104, peripheral devices 1106, communications interfaces 1107, memory 1108, and persistent storage 1110. Embodiments of the disclosure are not limited to this representative architecture. Alternative embodiments may employ different arrangements and types of components, e.g., separate buses for input-output components and memory subsystems.

Those skilled in the art will understand that some or all of the elements of embodiments of the disclosure, and their accompanying operations, may be implemented wholly or partially by one or more computer systems including one or more processors and one or more memory systems like those of computer system 1100. Some elements and functionality may be implemented locally and others may be implemented in a distributed fashion over a network through different servers, e.g., in client-server fashion, for example. In particular, server-side operations may be made available to multiple clients in a software as a service (SaaS) fashion.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method, comprising:
maintaining, in a computer-readable memory, a data record and a scheduling data structure associated with a first entity, wherein the data record includes a cycle start value, a cycle length and a maximum greeting value and wherein the scheduling data structure identifies two or more consecutive cycles and, for each cycle, one or more pre-existing scheduled greetings;
receiving, during a current cycle, a request for a first digital greeting, the request associated with a recipient user and identifying the first entity and a first delivery time;
determining whether the request meets a scheduling condition, at least in part, by:
accessing the computer-readable memory for the data record and the schedule data structure associated with the first entity;
rejecting the request, if the delivery time precedes the end of a second cycle associated with the analyst and immediately following the current cycle;
rejecting the request, if all cycles in the scheduling data structure that precede the delivery time include a number of non-movable, pre-existing scheduled greetings that equals the maximum greeting value, wherein a non-movable, pre-existing scheduled greeting is a pre-existing scheduled greeting having a delivery time that lies within a cycle corresponding to the first delivery time;
accepting the first digital greeting for creation in the second cycle, if the second cycle includes a number of pre-existing scheduled greetings to be created in the second cycle less than the maximum greeting value; and
modifying the scheduling data structure to schedule the first digital greeting for creation in a selected cycle if the scheduling condition is met.

2. The method of claim 1 wherein the selected cycle is a cycle that precedes the first delivery time and includes less than the maximum greeting value.

3. The method of claim 1 wherein the modifying the scheduling data structure to schedule the request for creation further comprises
selecting a first pre-existing scheduled greeting in a corresponding cycle that can be moved to a subsequent cycle, and modifying the scheduling data structure to schedule the first digital greeting in the corresponding cycle and to re-schedule the first pre-existing scheduled greeting in the subsequent cycle.

4. The method of claim 1 wherein the modifying the scheduling data structure to schedule the request for creation further comprises
if the second cycle includes a number of pre-existing scheduled greetings to be created in the second cycle equal to the maximum greeting value and the delivery time precedes the end of a third cycle immediately following the second cycle, then:
identifying whether a first pre-existing scheduled greeting in the second cycle can be moved to a subsequent cycle following the second cycle based on a delivery time associated with the first pre-existing scheduled greeting; and
modifying the scheduling data structure to schedule the first digital greeting for creation in the second cycle and the first pre-existing scheduled greeting for creation in the third cycle.

5. The method of claim 1 wherein one or both of the cycle length and the maximum greeting value are configurable by the first entity.

6. An apparatus, comprising;
a processor,
a network interface,
a memory comprising computer-readable instructions operative, when executed, to cause the processor to:
receive, during a current cycle, a request for a first digital greeting, the request associated with a recipient user and identifying the first entity and a first delivery time;
determine whether the request meets a scheduling condition, at least in part, by:
accessing, in a computer-readable memory, a data record and a scheduling data structure associated with a first entity, wherein the data record includes a cycle start value, a cycle length and a maximum greeting value and wherein the scheduling data structure identifies two or more consecutive cycles and, for each cycle, one or more pre-existing scheduled greetings;
rejecting the request, if the delivery time precedes the end of a second cycle associated with the analyst and immediately following the current cycle;
rejecting the request, if all cycles in the scheduling data structure that precede the delivery time include a number of non-movable, pre-existing scheduled greetings that equals the maximum greeting value, wherein a non-movable, pre-existing scheduled greeting is a pre-existing scheduled greeting having a delivery time that lies within a cycle corresponding to the first delivery time;
accept the first digital greeting for creation in the second cycle, if the second cycle includes a number of pre-existing scheduled greetings to be created in the second cycle less than the maximum greeting value; and
modify the scheduling data structure to schedule the first digital greeting for creation in a selected cycle if the scheduling condition is met.

7. The apparatus of claim 6 wherein the selected cycle is a cycle that precedes the first delivery time and includes less than the maximum greeting value.

8. The apparatus of claim 6 wherein to schedule the request for creation, the memory further comprises instructions operative to cause the processor to:
select a first pre-existing scheduled greeting in a corresponding cycle that can be moved to a subsequent cycle, and modify the scheduling data structure to schedule the first digital greeting in the corresponding cycle and to re-schedule the first pre-existing scheduled greeting in the subsequent cycle.

9. The apparatus of claim 6 wherein to schedule the request for creation, the memory further comprises instructions operative to cause the processor to: if the second cycle includes a number pre-existing scheduled greetings to be created in the second cycle equal to the maximum greeting value and the delivery time precedes the end of a third cycle immediately following the second cycle, then:
identify whether a first pre-existing scheduled greeting in the second cycle can be moved to a subsequent cycle following the second cycle based on a delivery time associated with the first pre-existing scheduled greeting; and
modify the scheduling data structure to schedule the first digital greeting for creation in the second cycle and the first pre-existing scheduled greeting for creation in the third cycle.

10. The apparatus of claim 6 wherein one or both of the cycle length and the maximum greeting value are configurable by the first entity.

11. A method for providing scheduling information on a user interface for ordering a greeting, the method comprising
displaying an indication of an analyst in a first region of the user interface;
displaying one or more availability indications in a second region of the user interface, wherein each of the one or more availability indications correspond to a respective calendar day and indicate the availability of a greeting composed by the analyst;
wherein the one or more availability indications are generated, in a current cycle, for each calendar day by
accessing, in a computer-readable memory, a data record and a scheduling data structure associated with the analyst, wherein the data record includes a cycle start value, a cycle length and a maximum greeting value and wherein the scheduling data structure identifies two or more consecutive cycles and, for each cycle, one or more pre-existing scheduled greetings;
generating a negative availability indication, if the calendar day precedes the end of a second cycle associated with the analyst and immediately following the current cycle;
generating a negative availability indication, if all cycles in the scheduling data structure that precede the calendar day include a number of non-movable, pre-existing scheduled greetings that equals the maximum greeting value, wherein a non-movable, pre-existing scheduled greeting is a pre-existing scheduled greeting having a delivery time that lies within a cycle corresponding to the calendar day;
generating a positive availability indication for the calendar days falling in the second cycle, if the second cycle includes a number of pre-existing scheduled greetings to be created in the second cycle less than the maximum greeting value.

12. The method of claim 11 further comprising
receiving a selection of a calendar day having a positive availability indication; and
modifying the scheduling data structure to schedule a first digital greeting for creation in a cycle that precedes the calendar day.

13. The method of claim 11 wherein the selected cycle is a cycle that precedes the first delivery time and includes less than the maximum greeting value.

14. The method of claim 12 wherein the modifying the scheduling data structure to schedule the request for creation further comprises
selecting a first pre-existing scheduled greeting in a corresponding cycle that can be moved to a subsequent cycle, and modifying the scheduling data structure to schedule the first digital greeting in the corresponding cycle and to re-schedule the first pre-existing scheduled greeting in the subsequent cycle.

15. The method of claim 12 wherein the modifying the scheduling data structure to schedule the request for creation further comprises
if the second cycle includes a number pre-existing scheduled greetings to be created in the second cycle equal to the maximum greeting value and the delivery time precedes the end of a third cycle immediately following the second cycle, then:
identifying whether a first pre-existing scheduled greeting in the second cycle can be moved to a subsequent cycle following the second cycle based on a delivery time associated with the first pre-existing scheduled greeting; and
modifying the scheduling data structure to schedule the first digital greeting for creation in the second cycle and the first pre-existing scheduled greeting for creation in the third cycle.

16. The method of claim 11 wherein one or both of the cycle length and the maximum greeting value are configurable by the first entity.
